(19) United States
(12) Patent Application Publication
(10) Pub. No.: US 2026/0361245 A1
(43) Pub. Date: Nov. 12, 2026

(54) GENERATOR POWER PEAK LIMITING IN WIND POWER INSTALLATIONS

(71) Applicant: VESTAS WIND SYSTEMS A/S, Aarhus N (DK)

(72) Inventors: Gert Karmisholt ANDERSEN, Hovedgård (DK); Hong GONG, Aalborg Øst (DK); Afonso Gil PORTUGAL DE SENA LOPES, Porto (PT); Torsten LUND, Fredericia (DK)

(21) Appl. No.: 19/124,960

(22) PCT Filed: Dec. 21, 2023
(86) PCT No.: PCT/DK2023/050323

§ 371 Date: Apr. 28, 2025

(30) Foreign Application Priority Data
Dec. 30, 2022 (DK) PA202270657

(51) Int. Cl. H02P 9/10; F03D 7/02; H02P 101/15

(52) U.S. Cl. CPC H02P 9/102; F03D 7/0284; F05B 2270/1033; H02P 2101/15

(57) ABSTRACT

The invention relates to a method for controlling wind power electrical generator transients. The wind turbine generator comprises a power converter comprising a machine side converter and a line side converter and a DC link. A grid voltage reference for controlling the line side converter is determined, and the power 5 supplied to the grid (PLsc) is controlled by the line side converter using a grid forming controller. The machine side converter and the electrical generator is controlled according to a power reference (PMsc). An error between a measured DC link voltage value and a DC link reference value is determined and, a voltage correction component is derived in response to the error signal. The voltage 10 correction component is added to the output voltage of the grid forming control, and the line side converter is operated according to the combined output voltages.

### FIELD OF THE INVENTION

The invention relates to control of power generation in wind turbines, and particular control of electrical generator power peaks in response to transient grid events.

### BACKGROUND OF THE INVENTION

In order to allow a higher penetration of renewable energy sources, such as wind turbines, in the electrical grid it has been proposed requirements to equip the power converters of wind turbines with grid-forming properties similar to conventional synchronous generators. These requirements can be addressed, for example, by configuring the renewable power generating units as virtual synchronous machines, VSM.

When a wind turbine is configured to be operated as a VSM or according to other grid forming control schemes, grid disturbances, such as phase jumps, may lead to high peaks in the generator power and/or generator torque, and thereby undesired transient mechanical loads.

Accordingly, it is a problem that wind turbines configured operating according to a grid forming control scheme may experience high mechanical loads in response to grid disturbances.

### SUMMARY OF THE INVENTION

It is an object of the invention to improve control of wind turbines comprising a power converter being configured to be controlled according to a grid forming control schemes in order to alleviate problems with transient mechanical loads.

According to a first aspect of the invention it is provided a method for controlling a wind power installation in order to limit electrical machine transients, the wind power installation comprising an aerodynamical rotor, an electrical machine with a stator and a rotor driven by the aerodynamical rotor, a power converter comprising a machine side converter connected to the stator and a line side converter configured to supply power to a grid, and a DC link electrically connected to an output of the machine side converter and an input of the line side converter. The method comprises:
determining a grid voltage reference for controlling the line side converter;
controlling the power supplied to the grid by the line side converter by controlling the line side converter using a grid forming controller configured to control the output voltage towards the grid voltage reference;
utilising a power reference for the machine power control;
controlling the machine side converter and the electrical machine according to the power reference;
utilising a DC link voltage control, deriving an error signal representing an error between a measured DC link voltage value and a DC link reference value, the error resulting from a power imbalance between the line side converter power and the machine side converter power;
deriving a DC link voltage correction component in response to the error signal;
adding the DC link voltage correction component to the output voltage of the grid forming control; and
operating the line side converter according to the combination of the output voltage from the grid forming controller and the DC link voltage correction component.

With regard to the power reference for the machine power control, the power being supplied to the grid may be feedforwarded for use as power reference, and/or a power reference may be received from, e.g., a power plant controller, PPC, or a grid operator, or be determined from active and reactive power references.

The electrical machine may be an electrical generator.

As was mentioned, requirements to equip wind turbine power converters with grid-forming properties that exhibit similarities to the behavior of conventional synchronous generators may be desired or even required. This may be accomplished by operating the line side converter according to a grid forming control scheme using a grid forming controller.

In the grid forming control scheme, the line side converter is controlled to produce an output voltage according to a grid voltage reference, where the grid voltage reference may be a reference provided, e.g., by an electrical grid operator, or an operator of, e.g. a wind farm, and where a plurality of power sources may be connected to the electrical grid for providing power. The grid voltage reference may comprise a voltage amplitude and frequency to be maintained by the particular wind turbine generator. The voltage reference may also be determined according to other criteria. This may be the case, for example, if the wind turbine generator is be configured to set up, e.g., a local electrical grid, i.e. operate in an island mode, where the voltage amplitude may be adapted according to the particular need for power of the connected consumers. Hence, in grid forming control, a wind turbine generator may create a power grid by powering otherwise depowered power lines.

The grid forming control is hence different from a more conventional grid following control, where, instead, grid-following converters synchronize to the currently prevailing grid voltage amplitude and frequency, where the line side converter adjusts the output voltage to track an external voltage reference, which is given by the currently prevailing voltage on the electrical grid.

In a steady state mode, the power balance in a grid following control is essentially such that the torque and speed of the electrical generator are constant, and hence the power output by the electrical generator. The DC link voltage of the DC link interconnecting the machine side converter and the line side converter is also constant, while the voltage output by the line side converter is variable so that the current being injected into the grid is adapted in amplitude to correspond to the prevailing power that is delivered by the electrical generator.

In case a fault or an unexpected event occurs in the electrical grid, the line side converter, when operating according to grid following control, in principle, will continuously adjust the voltage to the currently prevailing voltage on the grid, hence also in situations when the grid voltage deviates from the voltage the grid is intended to maintain. The grid following line side converter hence does not support the rigidity of the grid in situations of this kind, but simply follows voltage changes as they occur, and continue to provide the power generated by the electrical generator to the grid at the voltage amplitude and angle that the grid currently is operating at by adjusting the injected current in accordance therewith so that the injected power remains essentially the same.

The machine side converter, and thereby also the electrical generator, are hence substantially unaffected when abnormal grid events occur when operating in the grid following mode, since the produced power is continuously delivered to the DC link and onwards towards the grid irrespective of the prevailing grid voltage. The electrical generator, and other drive train components, can therefore be seen as being decoupled from the grid in terms of changes occurring on the grid, and therefore these components are also not subjected to potentially harmful voltage or torque transients because of changes in the grid voltage, since the power provided by the electrical generator can be continued to be provided to the grid at the same power level, or alternatively, or in addition, if power cannot be injected to the grid a dc link chopper may be used to dissipate the energy, still keeping the machine side unaffected, at least within the capability of the dc shopper. The apparent drawback of such control is the lack of support for system stability, which will have a higher and higher impact the larger the number of power sources that are connected to the grid in this manner.

Stability problems may, as was mentioned, be alleviated by the power source, instead, being controlled according to a grid forming control where the line side converter instead is configured to act as a grid stabilizer. The line side converter is then configured to control the output voltage towards a voltage reference and maintain this voltage reference, irrespective of the actually prevailing grid voltage in order to support the maintaining of the intended voltage.

This improves the stability of the grid, but as a result grid events, in particular transient changes, may impose harmful torque transients on wind turbine generator components. If something then happens in the grid, there will be an immediate current response that follows automatically when continuing to control the output of the line side converter towards the voltage reference. This will have the result that the current being injected into the grid, instead, will be a direct result of the voltage control of the line side converter.

As a result, according to this prior art solution, when the grid is subjected to transients, the current to be injected into the grid may also exhibit transients, and this will also affect the control of the DC link voltage when transients in DC link current occurs. The machine side converter controls the DC link voltage, and in order to maintain the DC link voltage at a DC link voltage reference, the request for power from the electrical generator undergoes corresponding transient changes to compensate for changes in the DC link, with the result that the transients may transplant to the machine side converter and thereby also to the electrical generator and other drive train components providing power to the machine side converter. For example, the aerodynamical rotor, as well as the electrical generator and the gearbox interconnecting the aerodynamical rotor and the electrical generator will be directly affected by such torque changes, and components of this kind do not react well to harmful torque spikes which may cause excessive wear. Also, components of the power converter may break if subjected to, e.g., excessive current spikes.

According to the invention, it is provided a control method that provides the desired grid forming control, while simultaneously alleviating mechanical components as well as converter components from excessive wear caused by transient events occurring on the grid.

According to the first aspect of the invention, a voltage reference for controlling the line side converter is determined, where this may be carried out as described above with regard to grid forming control, and hence be a voltage that the line side converter is to control the output voltage towards also when a voltage changing grid event occurs. Furthermore, the power being supplied to the grid by the line side converter is controlled by controlling the line side converter according to a grid forming control configured to control the output voltage towards the voltage reference. Hence, the general control of the electrical machine such as a wind turbine generator is carried out according to a grid forming control so as to provide a grid stabilising control.

The power supplied to the grid may be feedforwarded to the electrical generator control to be used as a power reference for the power control of the electrical machine, and the machine side converter and the electrical machine may be controlled according to this power reference. As was mentioned above, the power reference may also be determined in other ways. This is also in accordance with general grid forming control, where normally a transient change in the power supplied to the grid will be reflected in the power reference for the power control of the electrical generator, with possible harmful transients in mechanical components arising as a result in the sudden change in requested power.

According to the invention, such transients can be at least mitigated, or partly or fully eliminated by imposing a control mechanism for controlling the DC link voltage of the DC link. In general the DC link voltage is upheld by the power balance between power supplied by the machine side converter and power consumed by the line side converter, where, in order to uphold the DC link voltage, it is a requirement that the power provided by the machine side converter corresponds to the power being injected into the grid by the line side converter, where, as stated, transient changes in power to be injected into the grid will propagate to the machine (electrical generator) side.

According to the invention, instead of upholding the DC link voltage using control of the machine side converter, and thereby electrical machine, a DC link control is carried out where an error between a measured DC link voltage value and a DC link reference value is derived, where the error results from a power imbalance between the line side converter power and the machine side converter power, e.g., caused by a transient event on the grid.

A DC link voltage correction component is derived in response to the error signal, and the DC link voltage correction component is added to the output of the GFC output voltage. The line side converter is then operated with the combined DC link voltage correction component and the output voltage of the grid forming control. In this way a control of the DC link voltage is carried out in parallel to the general grid forming control of the power being injected into the grid, where the output voltage of the grid forming control is subjected to an addition, i.e. correction, by the DC link voltage correction component. The addition from the DC link control will at least in part compensate for transient events, so that the electrical generator do not solely need to account for such transient changes during grid forming control.

Hence the actual voltage being output by the line side converter will differ to an extent from the calculations resulting from the grid forming control by the addition of the voltage component resulting from the DC link control, but instead harmful transients on mechanical components may be reduced. The DC link control may be carried out in parallel to the grid forming control of the voltage to be output by the line side converter.

The DC link control may further be carried out according to a grid following control algorithm, where hence the line side converter may be controlled by a grid forming algorithm and a grid following algorithm operating in parallel. An advantage of the invention is that since grid forming control and a grid following control scheme are configured to run in parallel, the majority of the power being injected into the grid may be controlled according to a grid forming control, whereas a grid following control may be utilized to reduce harmful transients that otherwise would occur during the grid forming control.

According to embodiments of the invention, the measure of the power supplied to the grid that may be feedforwarded as power reference for the power control of the electrical generator, or the power referenced obtained according to other means, is processed prior to actually utilising the measure as power reference for the electrical generator. In this way, sudden changes in the power being supplied to the grid, and thereby also the power reference of the electrical generator, can be reduced while the maintenance of the DC link voltage is still ensured through the separate DC link voltage control.

According to embodiments of the invention, the processing of the power reference such as the measure of the line side power may comprise subjecting the measure of the power supplied to the grid by the line side converter to a limitation of the rate of change when transient changes in the power supplied to the grid by the line side converter occur. In this way it can be ensured that transient changes in the power being supplied to the grid are slowed down so that the power reference being used to control the electrical generator is varied at a slower rate, thereby reducing wear on mechanical components. This control of the rate of change would, when taken alone, have a negative impact on the DC link voltage, but which, as explained above, is compensated for by the separate DC link voltage control according to the invention.

As an alternative to, or in addition to, controlling the rate of change of the power reference of the electrical generator, the measure of the line side power and/or the result of the rate of change, may be low pass filtered prior to determining the electrical generator power reference. This may further reduce transient changes in the electrical generator power reference.

The invention hence allows that the electrical generator power reference deviates from the measure of the line side power the power difference, since the difference can be the difference in DC link voltage in relation to a DC link voltage reference caused by this power difference can be compensated using the DC link voltage control. The DC link control then compensates any power imbalance between machine side and line side converter and thereby keeps DC link voltage constant. This allows that a feedforward of the power reference to the generator can be limited in rate, bandwidth and/or peak so that only what is allowed by mechanics is feed to the generator power. The difference that arises by the limitations will be handled by the DC link control—and “returned” back to the grid. The DC link control thereby allows for imperfect “reference tracking”.

The DC link voltage control may hence be configured to influence the power and/or voltage of the power being supplied to the grid by the line side converter. In this way, power may be fed back to the grid during transient events by adding a voltage component that changes the output current of the line side converter, to thereby reduce negative transient impact on mechanical components.

According to embodiments of the invention, the deriving of the DC link voltage correction component comprises to convert the error between a measured DC link voltage value and a DC link reference value to a corresponding DC link error reference power and add the power being injected into the grid to this DC link error reference power. The current of the grid following control cannot be determined separately, only the total current injected into the grid can be measured. The addition of the total power allows that the measure of the total current can be used in the control. The resulting total power may then be divided by the prevailing grid voltage to form a reference current to be used in the grid following control, and by subtracting the total current being into the grid from this reference current, a control current representing the DC link voltage error is obtained, and which control current can be subjected to a PI-controller to form a reference voltage component to be used in the generation of the voltage correction component.

Furthermore, the drive train components in general exhibit fundamental frequency oscillations. These oscillations in general have a very low frequency. The power output by the electrical generator can be compensated by a drive train damping power to dampen drive train fundamental frequency oscillations, where the drive train damping power is compensated by supplying the drive train damping power to the grid. According to the invention, this compensation can be carried out by adding the drive train damping power to the power reference to the machine and will thereby occur as a power imbalance between machine and line side converter. This imbalance is then handled by the DC link control according to the invention so that this compensation need not be performed using the grid forming control.

Furthermore, grid forming control is in general restricted in regard of allowable control frequency. The grid forming control should not react on changes occurring in the grid in a particular frequency interval. This interval may, e.g., be 5 Hz to 1000 Hz, and hence any occurrences of faults/events in such frequency intervals is not to be reacted upon. This further emphasizes the problems in terms of transients transplanting to the drive train of the wind turbine generator, and the disability of being able to properly account for transients propagating through the components of the wind turbine generator. The use of the DC link voltage control allows controlling the DC link voltage more rapidly and for other frequency components than what is being utilized in the grid forming control of the output voltage of the line side converter, which provides for an efficient control and which also facilitates compensation for, e.g. low frequency components such as drive train damping power.

The grid forming control of the power being injected into the grid by the line side converter may be configured to be controlled according to various grid forming control algorithms. For example, the line side converter may be controlled to simulate a synchronous machine and hence be controlled, e.g. according to a swing equation as is well described in the art. According to embodiments of the invention, the grid forming control may instead be carried out, e.g. according to virtual oscillator grid forming, and/or moving average filtering grid forming or other grid forming methods.

An advantage of the invention is that since a grid forming control scheme and a grid following control scheme may be configured to run in parallel in order to carry out the control of the output voltage of the power being injected into the grid these two control loops are also in operation during normal operation of the wind turbine generator. This has the advantage that in case the control of the wind turbine generator is to be shifted, e.g. determined by a higher level power control, which e.g. may be configured to control the total power output by a plurality of power sources such as wind turbine generators and possible other power sources, there may be a decision to switch the control of the wind turbine generator to either grid forming control or grid following control. In such situations, a wind power generator operating according to embodiments of the invention will already have both a grid forming control loop and a grid following control loop already in operation, and the desired operation can be selected by simply turning of the control loop that at the moment is not intended to be utilized. According to embodiments of the invention it is hence provided for a time efficient switch of mode of operation.

### BRIEF DESCRIPTION OF THE DRAWINGS

Embodiments of the invention will be described, by way of example only, with reference to the drawings, in which:

FIG. 1 illustrates a wind turbine;

FIG. 2A illustrates an example of a power system of a wind turbine or a power generating unit, where generator is connected to the converter via the stator;

FIG. 2B illustrates control components arranged for controlling the generation of active power and reactive power supplied to the grid at the power output of the wind turbine or power generating unit;

FIG. 3 illustrates an example of a combined grid forming and DC link control according to the invention;

FIG. 4 illustrates a further example of a combined grid forming and DC link control according to the invention;

FIG. 5 illustrates a method of limiting changes of a generator power reference.

### DETAILED DESCRIPTION

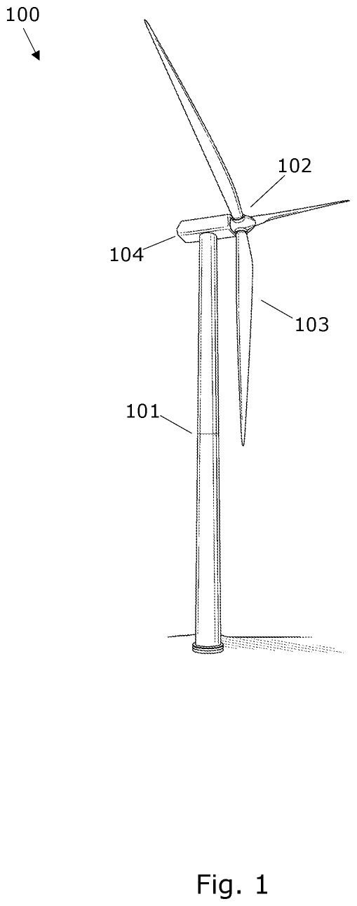

FIG. 1 shows a wind turbine 100 (WTG) comprising a tower 101 and a aerodynamical rotor 102 with at least one rotor blade 103, such as three blades. The aerodynamical rotor is connected to a nacelle 104 which is mounted on top of the tower 101 and being adapted to drive an electrical generator situated inside the nacelle via a drive train. The aerodynamical rotor 102 is rotatable by action of the wind. The wind induced rotational energy of the rotor blades 103 is transferred via a shaft, and oftentimes, as in the present case, a gearbox, to an electrical generator. The wind turbine 100 is hence capable of converting kinetic energy of the wind into mechanical energy by means of the rotor blades and, subsequently, into electric power by means of the electrical generator. The electrical generator, with a rotor and stator, the stator is connected to a power converter which comprises a machine side converter and a line side converter. The machine side converter converts the generator AC power into DC power and the line side converter converts the DC power into an AC power for injection into the grid.

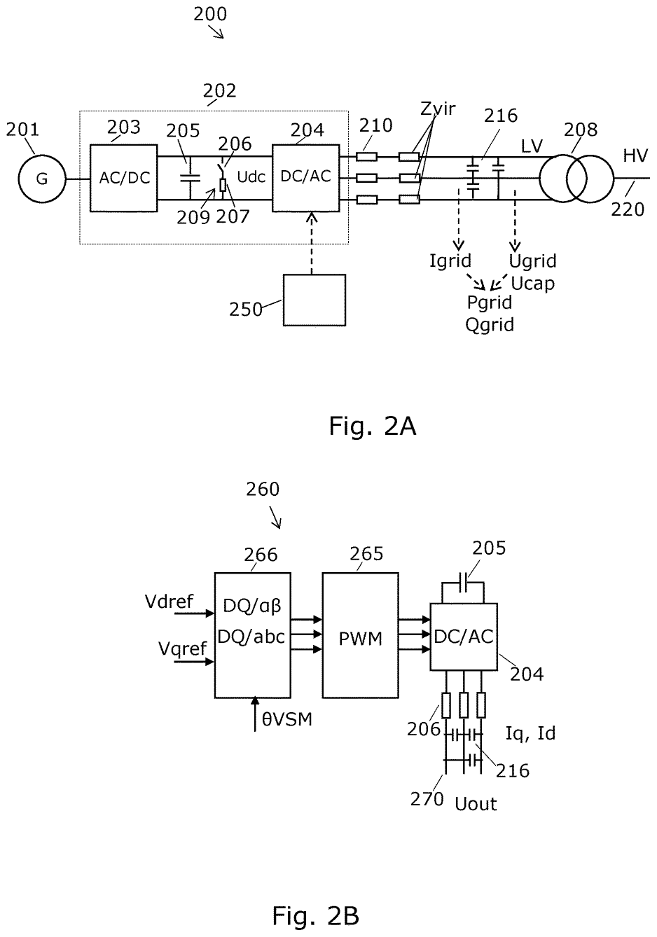

FIG. 2A shows an example of a power system 200 of a wind turbine such as the wind turbine 100 of FIG. 1 more in detail. The power system 200 comprises an electrical generator, or power source, 201, which according to the above is connected to the aerodynamical rotor 102 of the wind turbine 100, where oftentimes the drive train comprises a gearbox (not shown) connecting the aerodynamical rotor to the electrical generator. The power system 200 further comprises a power converter 202. The power converter 202 comprises a machine side converter 203, a line side converter 204 and a DC-link 205 therebetween, where in use a DC link voltage Udc is present. The power converter 202 may further comprise a resistor 207 connected with a controllable switch 206. The resistor and switch form a power dissipation device, also known as a chopper 209, for dissipating active power if the need for this arises which may be the case, e.g., if the wind turbine operates in island mode.

The DC-link 205 comprises one or more DC-link capacitors which are charged by the DC output current from the machine side converter 203 and which supplies DC power to the line side converter 204. The output AC current from the line side converter 204 may be supplied via output inductors 210 and possibly via a wind turbine transformer 208 to the grid or power line 220. In this example, the output AC current is a 3-phase current output. Furthermore, harmonic filter capacitors 216 may be arranged between the conductors of the output, which together with the inductors 210, forms a harmonic filter which converts the square wave voltage signals from the line side converter 204 to voltage sinusoidal signals.

The power line 220 may be a medium voltage power bus which receives power from other wind turbines 100. The power line 220 may be connected to a high voltage network, e.g. via further transformers. Thus, the power line 220 and one or more power systems 200 of corresponding wind turbines constitutes a wind power plant or park arranged to supply power to a utility grid for distribution of electrical power. The power line 220 and the high voltage network is commonly referred to as a power grid, or grid, herein.

The power converter 202 may be full-scale converter configured according to different principles including forced-commutated and line-commutated converters.

The power system 200 is only schematically illustrated and the system may be a three-phase system. However, principles of the described embodiments apply both to single and multi-phase systems.

The line side converter 204 utilizes pulse width modulation (PWM) for converting the DC power into AC power. The control system 250 is used for controlling the modulation of the line side converter 204 and for controlling the active power P and the reactive power Q generated by the line side converter 204.

FIG. 2A shows that the grid voltage Ugrid, here the voltage at the low voltage LV side of the transformer 208, can be measured. The grid voltage Ugrid can be used for controlling the power output of the converter, based on determining the active power Pgrid from grid voltage Ugrid and grid current Igrid. The reactive power Qgrid may similarly be determined from Ugrid and Igrid. Alternatively, the grid voltage Ugrid may be measured on the high voltage HV side of the transformer and corrected based on the turns ratio of the transformer, or the internal voltage magnitude reference Vqref is used instead of the measured voltage Ugrid. In an alternative, an internal voltage magnitude reference such as Vqref, Vdqref or VaBref may be used for determining Pgrid. The grid current Igrid supplied to the grid can also be measured.

FIG. 2B shows an example of control components 260 arranged for controlling the generation of active power Pgrid and reactive power Qgrid supplied to the grid at the power output 270 of the wind turbine 100. That is, the control components 260 may be arranged for controlling the output active power Pgrid and the output voltage magnitude at the low voltage side LV, alternatively for controlling the output active power Pgrid and the output reactive power Qgrid at the low voltage side LV. The control components 260 such as the frame conversion unit 266 and the pulse width modulator 265 may form part of the control system 250 or receive control signals from the control system 250.

References for the active and reactive power may be received from a power plant controller, PPC, or a grid operator, or be determined from active and reactive power references, e.g. from the grid operator. The illustrated system may be utilized in grid forming control, e.g. based on a virtual synchronous machine angle θVSM for active power control and where the voltage amplitude is provided through reactive power control. The voltage reference is the combination of the voltage amplitude and the voltage angle.

As was discussed above, the power converter may be controlled according to different control strategies, where historically a grid following methodology has been utilized. As was also mentioned, an advantage of the grid following control scheme is that since the line side controller controls the voltage in accordance with the prevailing voltage on the grid, the line side converter will immediately react to changes that occur on the grid and adjust, e.g., the current so that still the amount of power being injected into the grid corresponds to the amount of power being provided to the DC link by the machine side controller.

However, as was also discussed, there may exist a requirement from, e.g., a grid operator that the wind turbine generator take part in the forming of the grid and assists in the maintaining of the stability of the grid when stability affecting grid events occur. When the wind turbine generator operates according to a grid forming control scheme instead of a great following control speed the line side converter is operated to follow a fixed voltage reference irrespective of any stability influencing negative events occurring on the grid.

This may be accomplished through the use of a grid forming algorithm, where such grid forming algorithms may be of different kinds. For example, the active power, Pgrid, may be controlled using a virtual synchronous machine angle, θVSM as is schematically indicated in FIG. 2B. In short, the synchronous machine angle acceleration (the double-time derivative of θVSM) corresponds to the difference between a power reference Pref for a desired power output of the wind turbine and a grid power Pgrid that is actually supplied by the wind turbine to a power grid.

The synchronous machine angle θVSM may be determined according to a grid forming converter scheme such as a virtual synchronous machine control scheme. A grid forming converter scheme models the inherent rotating mass inertia of conventional synchronous generators. By modelling the inertia, the converter may provide improved grid stability by the grid forming converter model opposing changes in grid frequency. That is, an increase in the grid frequency causes an increase of the kinetic energy and rotation frequency of the inertia but with a response time determined by the inertia. Oppositely, a decrease in the grid frequency causes a decrease of the kinetic energy and frequency of the inertia but with a response time determined by the inertia. In a wind turbine, the increase or decrease of the kinetic energy of the modelled synchronous generator causes an increase or decrease of the kinetic energy of the aerodynamical rotor 102.

The synchronous machine angle θVSM may be used to transform the signals from a rotating DQ frame into a non-rotating frame such as the αβ or abc frame, or vice-versa. Based on the synchronous machine angle θVSM and voltage magnitude reference Vqref, control signals for the desired active power and reactive power are determined.

The synchronous machine angle θVSM may be defined in a rotating DQ frame defined by the angular position θVSM and rotating with the frequency ωVSM. Based on the synchronous machine angle θVSM, control signals, i.e. the angle of the modulation voltage signals for the pulse-width-modulator PWM, 265 are determined and transformed into a non-rotating frame such as the αβ or abc frame. The modulation voltage reference signal controls the active and reactive power Pgrid and Qgrid.

The frame conversion unit 266 transforms the control signal from the DQ frame into the αβ or abc frame and determines the sinusoidal voltage references for the PWM 265. The frame converted output signals from the frame conversion unit 266 are converted by the pulse-width-modulator PWM, 265 into a modulation signal for the grid side converter 204 in order to generate the desired active power and reactive power and/or voltage magnitude.

The voltage magnitude reference Vqref is provided as a reference for a desired grid voltage or a desired reactive power Qgrid to be generated by the converter 204. The voltage magnitude reference Vqref may be determined based on a difference between a reactive power reference Qref and an actual reactive power Qgrid delivered to the grid. Thus, the reactive power Qgrid to be generated by the line side converter 204 can be controlled based on a voltage magnitude reference Vqref. The voltage refence can also be a part of the grid forming.

The voltage magnitude reference Vqref may be defined in the DQ frame which rotates with the rotational speed ωVSM of the virtual synchronous machine, which in a steady state condition may equal the fundamental frequency such as 50 Hz of the AC grid voltage. The voltage magnitude reference Vqref, or a modification thereof as described in the following, may be converted from the DQ frame to the αβ or abc frame and outputted from the frame conversion unit 266 as a control signal to the pulse-width-modulator PWM, 265 which determines the modulation signal for the grid side converter 204. With regard to the DQ frame, it is to be noted that in the present description a generator notation of, e.g., Id, Iq, Ud, Uq, etc. is utilized, which differs from the general motor notation of, active and reactive currents and voltages.

As was mentioned, in a conventional synchronous machine the inherent inertia may be utilized for purposes of stabilizing the grid. In a wind turbine, the increase or decrease of the kinetic energy of the modelled synchronous generator causes an increase or decrease of the kinetic energy of the aerodynamical rotor 102. If these changes are transient, there will be a corresponding transient change in requirement for kinetic energy of the aerodynamical rotor 102, and thereby also other mechanical components.

Depending on the governing grid codes for a wind turbine power plant, the power converters of wind turbines may be required to be operated as virtual synchronous machines, at least for grid currents Igrid below a given overcurrent threshold. If the overcurrent threshold is high, grid disturbances like phase jumps may lead to a high power peak or torque peak in the generator side and drive train and consequently cause an undesired increase in the mechanical load.

For example, as was stated, the rotor carrying the wings, the electrical generator as well as the gearbox interconnecting these components may be sensitive to torque spikes to high degree. It is therefore highly undesirable to have high torque spikes occurring in the drivetrain since this may provide excessive wear and reduce lifetime expectancy of the components therein. This may therefore provide a challenge when it comes to controlling a wind turbine generator according to a grid forming control scheme.

According to the invention, it is provided a method of mitigating problems of this kind, where the grid forming control scheme is still utilized, but where a grid following control scheme is used in parallel to mitigate the impact of possible transients.

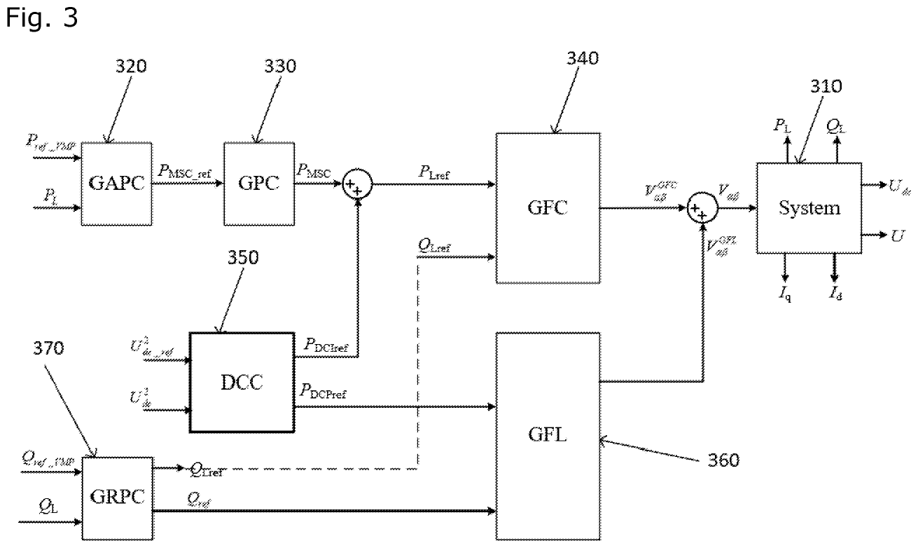

FIG. 3 illustrates a general principle according to the invention. In the figure, the line side converter and the associated control of the line side converter is schematically illustrated by the box 310, also denoted “system”. This box also represents the measurements of the DC link voltage Udc, which, e.g., may be measured on the input side of the line side converter. The system box 310 may also represent the power converter, the generator, the grid, etc. The system box 310 is furthermore responsible for determining measures of the active power PL that goes into the grid as well as the reactive power QL being injected into the grid. These measures may, for example, be determined from the grid voltage Ugrid and the grid current Igrid, which, as may be measured according to the above or according to alternative voltages measurements as was also stated. The active and reactive currents may also be established from these measures.

During constant operating conditions, the power PL being injected into the grid by the line side converter will be essentially the same as the power PMSC being provided by the machine side converter. However, the power being injected into the grid PL may need to be compensated for, e.g., power being drawn by auxiliary devices of the wind power converter and/or losses and/or other powers. According to the present example, there is therefore a generator active power controller GAPC 320 that takes as input the power reference Pref_VMP, which represents the desired power output of the wind turbine, and the power PL being injected into the grid and outputs a machine side active power reference PMSC_ref. Hence the actual power to be produced by the electrical generator may be set to the desired power output compensated for losses etc. so that the actually injected power PL corresponds to the power reference Pref_VMP. The machine side active power reference PMSC_ref is hence used to control the electrical generator, using the generator power control GPC 330 and the machine side converter to obtain the desired power on the DC link.

As was stated, references for the active Pref_VMP as well as for the reactive power QLref_VMP may be received from a power plant controller, PPC, or a grid operator, or be determined from active and reactive power references, e.g. from the grid operator. The power reference may reflect the power that is extracted from the wind, and hence may change e.g. in accordance with what the wind turbine generator is currently producing. Thus, the power reference Pref_VMP may reflect e.g. power changes caused by changes in the wind. In this way a power balance on the drivetrain is also obtained. As an alternative to the turbine reference power being reference to GAPC either PL or Pref_VMP can be selected as refence in GAPC, and also a combination may be utilized as power reference.

As was stated, the line side converter controls the output voltage based on a voltage input, such as a voltage Vαβ. This voltage input Vαβ consists, according to the present example, of two voltage components which will be explained in the following.

The power PMSC provided to the DC link by the machine side converter is utilized by a grid forming control GFC 340 to determine an output voltage VGFC, αβ to be output by the line side converter to obtain the desired power output, where, e.g. a grid forming control utilizing a virtual synchronous machine angle may control the active power being injected into the grid. It is to be noted that the output voltage component Vαβ, GFC may be generated according to any suitable grid forming control scheme, and hence not limited to controlling the line side converter according to a virtual synchronous machine. For example, virtual oscillator grid forming, and/or moving average filtering grid forming may be utilized as alternatives to controlling the line side converter as a virtual synchronous machine. The grid forming control GFC 340 carries out the required calculations based on a power PLref which comprises the power being output by the machine side converter, and a further component PDCIref which is described below. In addition, a reactive power reference QLref is also used.

The control according to GFC 340 in FIG. 3 is hence set out to control the line side converter according to a voltage reference. Use of this control alone, however, as is in general the case, exhibit drawbacks as explained above, since the electrical generator is no longer decoupled from the grid from a transient point of view in the same manner as when being controlled according to grid following control scheme because the rest of the system has to adapt to the control of the line side converter. The generator power control GPC will adapt to the power PL currently being input into the grid by the line side controller.

During normal operation there will be a balance between the power being output by the line side converter and the power being produced by the electrical machine. The power reference from the turbine Pref_VMP is respected since this reference provides information regarding the amount of power that can be injected into the grid according to the current power being extracted by the wind. However, if transients arise in the grid, the grid forming control GFC calls for the grid voltage to be maintained, and this will cause transients in the current that will be injected into the grid as a result of the maintaining of the voltage reference.

Thereby, there will also be a transient change in the power PL being injected into the grid by the line side converter, and as a consequence there will be a transient change in torque request from the electrical generator since a change in current output by the line side converter will be directly reflected by a change in the request for torque by the electrical generator. The DC link is in general very limited in terms of energy storage, and hence cannot account for sudden current changes. This means that power provided by the generator must immediately be delivered to the grid so that the DC link voltage can be kept at a desired level. The DC link voltage must be maintained constant in order to keep the converter operational, and this can hence only be ensured by keeping an energy balance between the electrical generator and the power injected into the grid. As a result transients will arise in the generator power/torque.

According to the solution of FIG. 3 problems of this kind are mitigated through the use of a separate DC link voltage control, which is implemented as a form of a grid following control. The grid forming control is hence combined with a grid following control, where the grid following control has the purpose of maintaining the DC link voltage at the desired voltage level. A DC link voltage control DCC 350 takes as input the currently prevailing DC link voltage Udc (squared), where this voltage may be established as described above. Furthermore, the DC link voltage control DCC 350 further takes as input the DC link voltage reference Udc_ref (squared). This DC link voltage control may be implemented in various ways, and, for example, comprise an integral controller (I-controller), and/or a proportional controller (P-controller) and/or a proportional-integral controller (PI-controller). According to the present example, the DCC 350 comprises a PI-controller, where the proportional part determines a power value PDCPref which is proportional with the DC link voltage difference and an integral part which determines a power value PDCIref which is proportional with a time integral of the DC link voltage difference. The integral part is a slowly changing part which is added to the power PMSC being injected into the DC link by the machine side converter. The slowly varying part PDCIref provides for DC link voltage stability during steady state operation by accounting for slow variations in the DC link voltage caused by variations and power differences in the normal operation of the wind turbine. The active power reference PLref being input to the grid forming control is the sum of the powers PMSC and PDCIref.

Transient changes in the DC link voltage, which according to the above may cause undesired stress and wear of the drive train components, is handled by a grid following control on the basis of the proportional part from the DCC. The proportional part determines a power value PDCPref which is proportional to the DC link voltage difference. This power value is input to a grid following control 360. In principle, the grid following control 360 calculates a voltage correction component Vαβ, GFL based on the power value PDCPref, which is then combined with the voltage component Vαβ, GFC being calculated by the grid forming control to form an overall output voltage Vαβ to be output by the line side converter. The voltage correction component Vαβ, GFL controls the DC link voltage towards the power reference, and hence counteracts voltage changes that the DC link would otherwise undergo.

Hence, when, e.g., a transient grid event occurs, according to the present example, a difference in the DC link voltage in relation to the DC link voltage reference will arise in situations where the electrical generator would normally be forced to operate outside its operating limits, but where hence these limits may now be respected since the transients need not be immediately propagated to the electrical generator. As is explained below, limits may also be imposed on the power refence PMSC_ref to further reduce the risk for potentially harmful transients in mechanical components.

Differences that arise in the DC link voltage as a result of changes in the power PL being injected into the grid and that are not immediate accounted for by corresponding changes in the power produced by the electrical generator are handled by the grid following control, which acts to return the DC link voltage level Udc towards the DC link voltage reference. In principle, the grid following control feeds back power to the grid instead of requesting the electrical generator to fully account for rapid changes in line side power.

The invention is hence a slight alteration of the general requirement that the line side converter in a grid forming mode is to always maintain the grid voltage reference, since the component added by the grid following algorithm will change the overall voltage output by the line side converter, but where this instead will reduce the stress that the electrical generator, and other drivetrain components, may undergo when transient events occur on the grid. Simultaneously it may be avoided that the converter trips altogether and becomes unusable in the process of maintaining grid stability, and also in regard of providing power to the grid until operation can be reset. Hence it is provided a means that in addition to reducing harmful transients may increase the use of the converter grid stabilizing operations.

In general, the power added by the grid following algorithm, and hence the influence on the overall output voltage, will be small in comparison to the overall power being output on the grid, and hence the impact on the maintaining of the grid stability may also be little. However, it may be the case in certain situations that the initial power being controlled by the grid following algorithm in a grid event may be large, and even exceed the power that at that time is controlled through the grid forming algorithm, but this will only be the case for as long as the machine side control has not had time to adapt to the new power requirements in view of the applied limitations regarding rate of change etc. Following such initial situations the control of the output voltage will more and more return to be controlled according to the grid forming algorithm. As is understood, this control may be fast, and following the initial transients the grid following algorithm will again control only small changes in DC link voltage.

FIG. 3 also illustrates a reactive power control GPRC, which is utilized for reactive power control. The reactive power control loop is required to ensure that reactive power is not unnecessarily produced. Still, both the active and the reactive power are required to form the overall output power, and it is therefore necessary to produce reactive power, e.g. in order to control the virtual electrical machine angle.

The reactive power control GPRC 370 takes as input a reactive power reference Qref_VMP, which represents the desired reactive power output of the wind turbine, which may be determined in a manner similar to the active power reference, and the reactive power QL being injected into the grid. The reactive power control GPRC 370 outputs a general reactive power reference QL_ref, which is provided to the grid forming control 340 and form part of the output voltage generated by the grid forming control. The reactive power control GPRC also outputs a reactive power reference Qref being input to the grid following control to be controlled in a manner similar to the active power grid following control, and which form part of the resulting output voltage component from the grid following control.

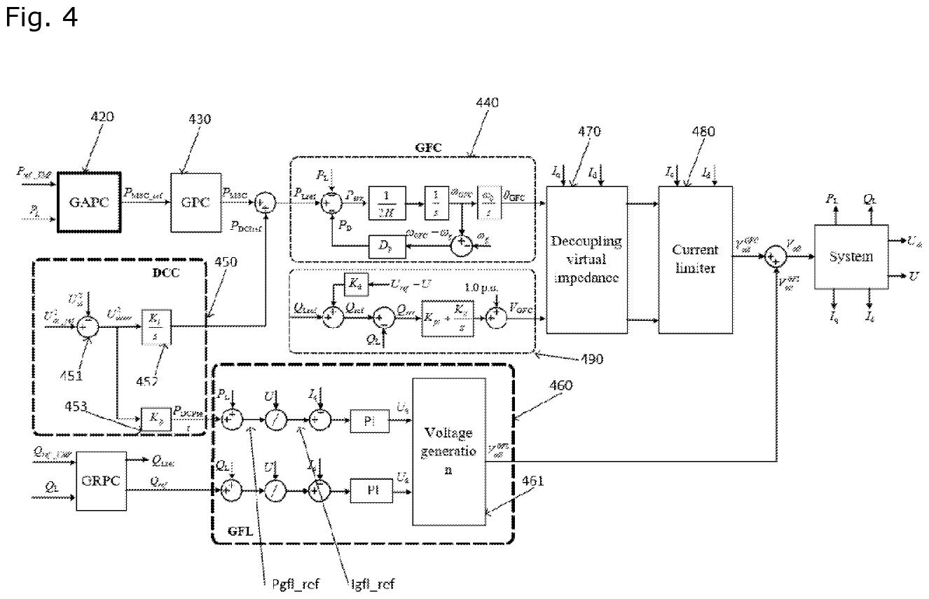

FIG. 4 illustrates a further embodiment according to embodiments of the invention. GAPC 420 and GPC 430 are similar to FIG. 3, and therefore not discussed further. With regard to the DC link control DCC 450 the determination 451 of the DC link voltage error signal Udcerr (squared) is illustrated, as well as the I-controller 452 for generation of the integral part PDCIref of the error signal and also the P-controller 453 for generation of the proportional part PDCPref of the error signal. These signals are used as described above with reference to FIG. 3.

The proportional power component PDCPref being output by the DC link control DCC 450 is, as above, provided to a grid following control, schematically indicated by 460, where the power component PDCPref is first added together with the power PL being injected into the grid. The reason for this is that only the total currents Id and lq can be measured, i.e. the combination of the outputs from the grid forming control and the grid following control. It is not possible to separately measure currents relating specifically to the grid forming control and the grid following control, respectively. The total power obtained from this addition, forming a grid following reference power Pgfl_ref, is then divided by the voltage U to form a grid following reference current Igfl_ref. The current Iq is subsequently subtracted from the grid following reference current Igfl_ref. This will have as result that the grid following GFL control component will follow the power reference Pgfl_ref which hence is representation of the power needed to correct the DC link voltage. The resulting current is subjected to a PI-controller for generating a voltage component that then is utilized by a voltage generator 461 to generate the output voltage Vαβ, GFL to be combined with the output Vαβ, GFC from the grid forming control, and which compensates the current to be output by the line side converter so that the DC link voltage can be maintained. It is to be noted that this PI-controller may alternatively be a P-controller.

The grid following control 460 also illustrates a similar generation of a reactive power voltage component which operates in the same manner and which also forms part of the grid following control output voltage being generated in the voltage generator 461.

In addition to illustrating an example the grid following control more in detail, FIG. 4 also illustrates an example of a grid forming control algorithm 440 for determining a synchronous machine angle θGFC of a virtual synchronous generator.

The synchronous machine angle θGFC is determined based on a virtual synchronous machine control concept which aims at generating a power response which corresponds to the power response from a real synchronous generator, including the inertia of the synchronous generator.

A power error Perr is determined as a difference between PLref as defined above and the power PL being injected into the grid and a damping power PD determined according to the virtual synchronous model.

In response to a change in the grid power PL, e.g. due to an decrease in the grid voltage Ugrid and a corresponding increase in the grid current Igrid, the power error Perr becomes non-zero, which causes the angle θVSM to increase or decrease to reduce the power error Perr. Thus, in response to fluctuations in e.g. the grid power Pgrid, the synthetic inertial response value becomes non-zero, which causes the virtual machine to either accelerate or decelerate to reach a new equilibrium condition. The new equilibrium is reached when PL is again following PLref.

The virtual synchronous model includes a closed loop where the virtual synchronous machine rotational speed from the grid forming control ωGFC is determined based on a combination of a feedback of the damping power PD, and the power reference PLref for the desired active power output of the wind turbine, and the active grid power PL supplied by the wind turbine to the grid.

The inertial integration model is according to the illustrated example implemented as 1/(2 Hs) where H is the inertia time constant and 1/s is the integration in s-domain where Perr is used as input for the inertial integration model.

The damping power PD is determined as the difference between the rotational speed of the grid ωg and the synchronous machine rotational speed ωGFC multiplied with the damping factor Dp. The damping factor Dp dampens the performance of the control loop of the grid forming control.

The synchronous machine angle θGFC is determined based on an integration of the synchronous machine rotational speed ωGFC according to ω0/s, where ω0 is the rated synchronous generator speed.

FIG. 4 further illustrates a decoupling virtual impedance 470, which may or may not be used, and is mainly used when there is a strong grid. In such situations a small variation in synchronous machine angle θGFC may result in a high power difference. The virtual impedance 470 alters the voltage a little to provide a decoupling between the active and reactive power loop. This improves system stability. The figure also shows a current limiter 480 which may be used to ensure that currents do not exceed set limits by keeping the currents below such limits. During normal operation no such limitation is in general needed. The virtual impedance may be determined for one or more phases. By increasing the resistive and/or the reactive value of the virtual impedance, the output current drawn from the output of the line side inverter can be reduced. The virtual impedance may be used to reduce acceleration of the virtual synchronous generator during overcurrent situations and thereby the output current Igrid of the line side inverter. FIG. 4 further illustrates the reactive power control 490 of the grid forming control, which in a manner known per se provides the voltage amplitude, while the active power control provides the voltage angle. Hence the active power control and the reactive power control together form the voltage amplitude and angle that is output by the grid forming control. The reactive control is not discussed in detail, since the invention relates to active power control Uref in the reactive power control could be a local setting, or be received from an external source.

Furthermore, as was indicated above, the invention allows for utilizing limits regarding, e.g., rate of change of the power/torque produced by the electrical generator, where this may be accounted for when determining the power reference being used by the machine side controller.

According to embodiments of the invention, the machine side power reference may instead be set following the applying of limits regarding, e.g., rate of change of the power/torque produced by the electrical generator, so that this may be accounted for when determining the power reference that form the basis for the machine side controller. Hence, according to embodiments of the invention, it may be further ensured that the electrical generator and drive train are not subjected to harmful transients, or at least that the transients are reduced through this control, but where still the grid following control according to the invention handles the differences in DC link voltage that this may give rise to.

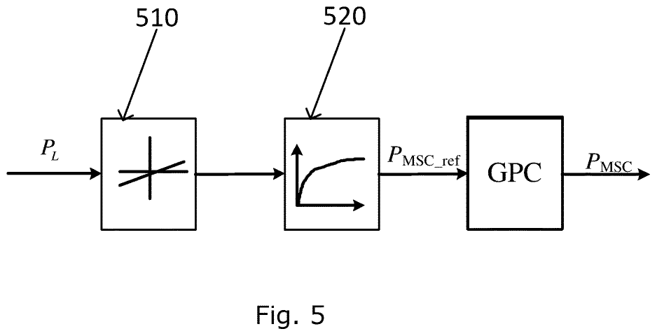

This is schematically illustrated in FIG. 5, where the measure of the power PL supplied to the grid by the line side converter is processed prior to utilizing the measure of the power PL supplied to the grid by the line side converter as electrical generator power reference PMSC_ref. According to the illustrated example, the measure of the line side power is subjected to a limitation 510 of the rate of change so that transient changes in the power PL will not be immediately reflected in the generator power reference. The measure may also be low-pass filtered 520 prior to determining the electrical generator power reference PMSC_ref being forwarded to the generator power control GPC. This gives rise to a power difference, but as explained this is handled by the grid following control according to the invention.

Furthermore, with regard to the illustrated powers, i.e., machine side power and line side power these may, as is known to a person skilled in the art, comprise power components that does not form part of the usable energy being injected into the grid. Such power components may, for example, comprise power losses, drivetrain damping power, power being consumed by auxiliary components etc.

For example, the drivetrain damping power may be an AC power where, e.g., a frequency in the order of 1 to 3 Hz may be utilized in an attempt to dampen low-frequency oscillations being inherent in the drivetrain when in use, where such oscillations may be a result, e.g., of drivetrain resonance frequencies. Power components of this kind may be comprised in the calculations when determining e.g. power reference levels in conventional grid forming control.

Part of the functionality of the generator control is to extract the desired average power and also dampen the drivetrain to account for the low-frequency oscillations resulting from resonance frequencies of the drivetrain.

According to the invention this may be compensated for as a component of the reference power that is provided to the DC link for being injected into the grid. That is, the drive train damping power may be added to the power reference of the electrical generator, and will thereby give rise to an imbalance that is governed by the DC link control. Other powers having different frequencies than the main grid frequency may added in a similar manner to this control as well.

A further advantage with the invention is that with regard to grid forming there may be a frequency interval in which no control is to be carried out and this also means that it may impose difficulties with regard to propagating e.g. the drive train damping power into the grid using the very slow control of up to e.g. a maximum 5 Hz that is still available, and the grid forming control which hence then it would also be used for the very slow variations of e.g. 1 to 2 Hz of the drive train damping power. This may therefore be difficult to fully account for in grid forming control algorithms. The DC link voltage control may be configured to control the DC link voltage at a higher control frequency than the control frequency being utilized, or even allowed, in the control of the output voltage of the line side converter. This facilitates control of, e.g., low frequency power components.

1. A method for controlling a wind power installation in order to limit electrical machine transients, the wind power installation comprising a aerodynamical rotor, an electrical machine, with a stator and a rotor, driven by the rotor, a power converter comprising a machine side converter connected to the stator and a line side converter configured to supply power to a grid, and a DC link electrically connected to an output of the machine side converter and an input of the line side converter, the method comprising:
determining a grid voltage reference for controlling the line side converter;
controlling the power supplied to the grid (PLsc) by the line side converter by controlling the line side converter using a grid forming controller configured to control the output voltage towards the grid voltage reference;
utilising a power reference (PMsc), for the machine power control; controlling the machine side converter and the electrical machine according to the power reference (PMsc);
utilising a DC link voltage control, deriving an error signal representing an error between a measured DC link voltage value and a DC link reference value, the error resulting from a power imbalance between the line side converter power and the machine side converter power;
deriving a DC link voltage correction component in response to the error signal;
adding the DC link voltage correction component to the output voltage of the grid forming control; and
operating the line side converter according to the combination of the output voltage from the grid forming controller and the DC link voltage correction component.

2. Method according to claim 1, further comprising:
deriving the DC link voltage correction component for maintaining the DC link voltage in parallel to the grid forming controller controlling the output voltage towards the grid voltage reference.

3. Method according to claim 1, wherein the DC link voltage correction component is derived using grid following control, the line side converter being controlled by a grid forming control and a grid following control operating in parallel.

4. Method according to any one of the claim 1, the method further comprising:
utilizing a measure of the power supplied to the grid by the line side converter as power reference,
processing the measure of the power supplied to the grid by the line side converter, and
utilizing the processed measure of the power supplied to the grid by the line side converter as electrical machine power reference.

5. Method according to claim 4, wherein the processing of the measure of the line side power comprises one or more from:
subjecting the measure of the power supplied to the grid by the line side converter to a limitation of the rate of change when transient changes in the power supplied to the grid by the line side converter occur;
low pass filtering the measure of the line side power and/or the result of the rate of change prior to determining the electrical machine power reference.

6. Method according to claim 4, wherein, when the electrical machine power reference deviates from the measure of the line side power:
compensating the difference in DC link voltage in relation to a DC link voltage reference caused by the power difference using the DC link voltage correction component.

7. Method according to claim 1, wherein:
the DC link voltage correction component is configured to influence the power and/or voltage of the power being supplied to the grid by the line side converter.

8. Method according to claim 1, wherein the deriving of the DC link voltage correction component comprises:
converting the error between a measured DC link voltage value and a DC link reference value to a corresponding DC link error reference power (PDCPref),
adding the power (PL) being injected into the grid to the DC link error reference power (PDCPref),
dividing the resulting power by the prevailing grid voltage so as to form a reference current (Pgfl_ref),
subtracting the total current being into the grid from the reference current,
subjecting the result to a PI-controller to form a reference voltage component, and
generating the DC-link voltage correction component;

9. Method according to claim 1, further comprising:
compensating power output by the electrical machine by a drive train damping power to dampen drive train fundamental frequency oscillations, the drive train damping power being compensated by supplying the drive train damping power to the grid, wherein
the drive train damping power is added to the power reference (PMsc).

10. Method according to claim 1, further comprising:
controlling the DC link voltage using a higher frequency bandwidth than the frequency bandwidth being utilized in the control of the output voltage of the line side converter.

11. Method according to claim 1, wherein:
the grid forming controller is configured to control the output voltage towards the grid voltage reference by determining a virtual synchronous machine angle.

12. A computer program comprising instructions which, when the program is executed by a computer, cause the computer to carry out the method according to claim 1.

13. A computer-readable medium comprising instructions which, when the instructions are executed by a computer, cause the computer to carry out an operation for controlling a wind power installation in order to limit electrical machine transients, the wind power installation comprising a aerodynamical rotor, an electrical machine, with a stator and a rotor, driven by the rotor, a power converter comprising a machine side converter connected to the stator and a line side converter configured to supply power to a grid, and a DC link electrically connected to an output of the machine side converter and an input of the line side converter, the operation comprising:
determining a grid voltage reference for controlling the line side converter;
controlling the power supplied to the grid (PLsc) by the line side converter by controlling the line side converter using a grid forming controller configured to control the output voltage towards the grid voltage reference;
utilising a power reference (PMsc), for the machine power control; controlling the machine side converter and the electrical machine according to the power reference (PMsc);
utilising a DC link voltage control, deriving an error signal representing an error between a measured DC link voltage value and a DC link reference value, the error resulting from a power imbalance between the line side converter power and the machine side converter power;
deriving a DC link voltage correction component in response to the error signal;
adding the DC link voltage correction component to the output voltage of the grid forming control; and
operating the line side converter according to the combination of the output voltage from the grid forming controller and the DC link voltage correction component.

14. A wind power installation control system arranged for limiting electrical machine transients in a wind power installation, the wind power installation comprising an aerodynamical rotor, an electrical machine, with a stator and a rotor driven by the aerodynamical rotor, a machine side converter connected to the stator, a line side converter configured to supply power to a grid, and a DC link electrically connected to an output of the machine side converter and an input of the line side converter, the wind power installation control system being configured to perform an operation, the operation comprising:
determining a grid voltage reference for controlling the line side converter;
controlling the power supplied to the grid (PLsc) by the line side converter by controlling the line side converter using a grid forming controller configured to control the output voltage towards the grid voltage reference;
utilising a power reference (PMsc), for the machine power control; controlling the machine side converter and the electrical machine according to the power reference (PMsc);
utilising a DC link voltage control, deriving an error signal representing an error between a measured DC link voltage value and a DC link reference value, the error resulting from a power imbalance between the line side converter power and the machine side converter power;
deriving a DC link voltage correction component in response to the error signal;
adding the DC link voltage correction component to the output voltage of the grid forming control; and
operating the line side converter according to the combination of the output voltage from the grid forming controller and the DC link voltage correction component.

15. A wind power installation comprising:
an aerodynamical rotor;
an electrical machine, with a stator and a rotor driven by the aerodynamical rotor; and
a power converter comprising a machine side converter connected to the stator, a line side converter configured to supply power to a grid, and a DC link electrically connected to an output of the machine side converter and an input of the line side converter; and
a wind power installation control system being configured to perform an operation, the operation comprising:
determining a grid voltage reference for controlling the line side converter;
controlling the power supplied to the grid (PLsc) by the line side converter by controlling the line side converter using a grid forming controller configured to control the output voltage towards the grid voltage reference;
utilising a power reference (PMsc), for the machine power control; controlling the machine side converter and the electrical machine according to the power reference (PMsc);
utilising a DC link voltage control, deriving an error signal representing an error between a measured DC link voltage value and a DC link reference value, the error resulting from a power imbalance between the line side converter power and the machine side converter power;
deriving a DC link voltage correction component in response to the error signal;
adding the DC link voltage correction component to the output voltage of the grid forming control; and
operating the line side converter according to the combination of the output voltage from the grid forming controller and the DC link voltage correction component.
